(19) United States
(12) Patent Application Publication
(10) Pub. No.: US 2025/0319451 A1
(43) Pub. Date: Oct. 16, 2025

(54) PLASMA ARC PROCESS AND APPARATUS FOR THE PRODUCTION OF FUMED SILICA

(71) Applicant: HPQ SILICA POLVERE INC., Montréal (CA)

(72) Inventors: Ali SHAHVERDI, Verdun (CA); Jean-René GAGNON, Boisbriand (CA); Pierre CARABIN, Montréal (CA)

(21) Appl. No.: 18/561,115

(22) PCT Filed: May 16, 2022
(86) PCT No.: PCT/CA2022/050770

§ 371 Date: Nov. 15, 2023

Related U.S. Application Data
(60) Provisional application No. 63/189,069, filed on May 15, 2021.

(51) Int. Cl. B01J 19/08; C01B 33/18; H05H 1/48

(52) U.S. Cl. CPC B01J 19/088; C01B 33/18; B01J 2219/0809; B01J 2219/083; B01J 2219/0869; B01J 2219/0871; H05H 1/48

(57) ABSTRACT

An apparatus for producing fumed silica from silica is described, wherein a plasma arc reactor includes at least one top electrode extending to the molten silica contained in the reactor, a conductive plate provided under the molten silica and a bottom anode. A plasma arc is adapted to be generated, wherein the plasma arc is provided at a tip of the electrode and is adapted to be transferred directly to the molten silica for forming SiO. A quenching system is also provided, such as hydrogen and oxygen containing gases that are injected within the reactor. The quenching system is adapted to reform SiO2 but in nano-sized amorphous particles, with a reactor outlet being provided for allowing the amorphous SiO2 nano particles in the form of fumed silica to exit the reactor.

### CROSS REFERENCE TO RELATED APPLICATIONS

This application claims priority on U.S. Provisional Application No. 63/189,069, now pending, filed on May 15, 2021, which is herein incorporated by reference.

### FIELD

The present subject matter relates to the production of fumed silica and, more particularly, to producing fumed silica with a plasma arc.

### BACKGROUND

Fumed silica, an inert and non-hazardous substance, is a common thickening agent used in various industrial applications. Fumed silica has high surface area and low bulk density, making it a valuable raw material for various products, including paints, foods, cosmetics, and catalysts, most often used as a thickener or desiccant. A small amount of fumed silica (1-5 wt. %) can have a large impact on the rheological properties of a liquid, such as the viscosity of a paint. It is also used as a light abrasive and free-flowing agent in bulk materials.

Fumed silica consists of long 3D chain nano-sized silica molecules. The complex formation of these chains leads to a product with a low bulk density, a very large specific surface area (+50 m²/g), and a strong thickening effect.

Fumed silica is conventionally produced by flame hydrolysis and it is a product of the complex process of silicon production as follows. Silica in the form of quartz is extracted from a mine, it is crushed to a certain size range and is then reduced to silicon or ferrosilicon in an arc furnace in the presence of a carbon source, and iron in the case of ferrosilicon, consuming large amounts of energy, resulting in a great quantity of CO₂ emissions, and generating solid byproducts such as silica fume, another form of silica, and slag. Silicon is then transported to a different facility, often overseas, where it is transformed into SiCl₄ using HCl and Cl₂ gases. The SiCl₄ is then combusted in a flame hydrolysis process using hydrogen and oxygen. The resulting product is a different type of silica (SiO₂) than the starting material, differing in its physical morphology and structure, and its surface chemistry. The overall process is multistep and highly polluting, emitting both greenhouse gases (GHGs) and acid gases.

Considering the complete product lifecycle, the conventional process of making fumed silica has a high carbon footprint of 16.4 kg CO₂ eq per kg of product [Ref. 1]. Moreover, the conversion yield of the process in each step is lower than 100%, for instance at best industrial practice the conversion yield of silicon in silicon production is only 80%, whereby about 20% of silicon is lost in the form of silica fume, resulting in the loss of materials.

It would therefore be desirable to transform silicon dioxide directly into fumed silica in one single step, with lower emissions of pollutants including GHGs and at a lower cost. This can be achieved by direct vaporization and decomposition of SiO₂ into SiO at high temperature and its reoxidation to SiO₂. Because of the high temperatures required in this process (+1,700° C.), conventional heating methods, such as combustion flames by burners, are not adapted to this process. Conventional electrical heating methods (for example resistive heating elements) are also not adapted for this process because they cannot attain the high temperature required for the process and the elements would become coated by the fumes, thereby affecting their efficiency. One way to achieve the high temperatures required by the process is to use a plasma arc reactor. A plasma arc can attain a temperature exceeding the decomposition temperature of silica, which meets the requirements of the process. The plasma arc is also not subject to fouling or loss in efficiency during the fumed silica production process. Moreover, the plasma arc process is highly scalable.

Research conducted by several universities has led to the current state of the art of producing fumed silica based on the use of transferred arc plasma torch technology.

Addona (M. Eng. Thesis, Addona, 1993, McGill University, Montreal, Canada) produced fumed silica in a laboratory scale plasma process using a transferred DC arc water-cooled plasma torch. This project studied how varying quench conditions affected fumed silica properties. Fumed silica was successfully produced using radiative energy from a plasma process. High surface area powders resulted from high pre-quench temperatures, high quench rates, and low pre-quench supersaturation ratios.

Addona (Ph.D. Thesis, Addona, 1998, McGill University, Montreal, Canada) investigated a new technique for fumed silica production by transferring a plasma arc to molten silica to significantly improve the energy efficiency of the process using a transferred DC arc water-cooled plasma torch. The successful arc transfer led to a patent: Method of Forming an Oxide Ceramic Electrode in a Transferred Plasma Arc Reactor (Canadian Patent No. 2,212,471 issued on Apr. 1, 2003 and U.S. Pat. No. 6,060,680 issued on May 9, 2000). In this study, the fumed silica produced had competitive surface areas but lacked thickening capabilities.

Pristavita (M. Eng. Thesis, Pristavita, 2006, McGill University, Montreal, Canada) examined the effects of agglomeration on fumed silica rheological properties. It concluded that agglomeration did not enhance rheological properties; lack of thickening was due to the absence of free hydroxyl groups on the product surface. Quenching conditions were tested and resulted in a product with high overall quality and competitive surface areas, measuring up to 260 m²/g.

The use of transferred arc plasma torches for the production of fumed silica as described in the above-mentioned references has several drawbacks, namely high operational costs due to the relatively poor heat efficiency of the torches since a significant part of energy is dissipated and lost in the torch water cooling circuit, inferior scalability, and a risk of water leakage into the reactor which can lead to catastrophic steam explosions due to the water reacting with the molten bath of silica.

It would therefore be desirable to provide a new process and apparatus that can produce high quality fumed silica in one step.

### SUMMARY

It would thus be desirable to provide a novel process and apparatus that can produce high quality fumed silica.

The embodiments described herein provide in one aspect a plasma process for producing fumed silica continuously with lower energy requirement and lower carbon footprint than conventional processes.

Also, the embodiments described herein provide in another aspect an apparatus to melt, vaporize, and decompose silica, and subsequently to quench the vapor phase to form and functionalize fumed silica in one step.

Furthermore, the embodiments described herein provide in another aspect a plasma arc process to convert silica directly to fumed silica.

Furthermore, the embodiments described herein provide in another aspect a plasma arc process for making fumed silica that is substantially waste free and does not generate any hazardous waste.

Furthermore, the embodiments described herein provide in another aspect an apparatus to thermally decompose silica to silicon monoxide without any reducing agent.

Furthermore, the embodiments described herein provide in another aspect a plasma arc process for producing fumed silica, including the steps of:
feeding silica, such as crushed quartz, into a plasma arc reactor;
generating within the reactor a plasma arc at a tip of at least one top electrode;
transferring the plasma arc directly to a molten silica contained in the reactor, forming SiO;
quenching the SiO, to reform SiO₂ but as nano amorphous particles; and
removing the SiO₂ nano amorphous particles in the form of fumed silica from the reactor.

Furthermore, the embodiments described herein provide in another aspect an apparatus for producing fumed silica, comprising a reactor adapted to generate a plasma arc, at least one top electrode extending to molten silica contained in the reactor, a conductive plate provided under the molten silica, a bottom anode, wherein a plasma arc provided at a tip of the electrode is adapted to be transferred directly to the molten silica for forming SiO, a quenching system, such as hydrogen and oxygen containing gases that are injected within the reactor, being adapted to reform SiO₂ into nano-sized amorphous particles, and an outlet for allowing fumed silica to exit the reactor.

Furthermore, the embodiments described herein provide in another aspect that a path of electrical current flowing through the reactor starts at the electrode, forms the plasma arc between the electrode and the molten silica, and flows through the conductive molten silica down to the conductive plate, and then through the bottom anode.

Furthermore, the embodiments described herein provide in another aspect that the bottom anode is provided with cooling fins, and that an air blower is provided for cooling the cooling fins.

Furthermore, the embodiments described herein provide in another aspect that the quenching system includes at least one gas injection port.

Furthermore, the embodiments described herein provide in another aspect that a cyclone is provided for collecting larger size fumed silica agglomerates, as a stream of hot gas and fumed silica particles exit the reactor through the outlet.

Furthermore, the embodiments described herein provide in another aspect that a gas/liquid cooler is provided downstream of the cyclone for cooling the stream of hot gas.

Furthermore, the embodiments described herein provide in another aspect that a baghouse-type filter is provided downstream of the gas/liquid cooler for separating most of the finer fumed silica particulates from the gas stream.

Furthermore, the embodiments described herein provide in another aspect that a fine particulate filter is provided downstream of the baghouse-type filter for further filtering the gas and removing fumed silica traces.

Furthermore, the embodiments described herein provide in another aspect that an induced draft fan is provided downstream of the fine particulate filter for drawing the gas out of the reactor and for providing a sub-atmospheric pressure.

Furthermore, the embodiments described herein provide in another aspect a plasma arc process for producing fumed silica, including the steps of:
feeding silica, such as crushed quartz, into a plasma arc reactor;
adding additive(s) to fed silica to enhance: electrical conductivity of silica melt, and/or to lower its melting temperature, and/or to improve fumed silica production rate and/or its quality;
generating within the reactor a plasma arc at a tip of at least one top electrode;
injecting through the top electrode gasses to enhance the production of fumed silica
by reducing vaporization energy of silica,
by increasing arc power to enhance silica vaporization rate,
by introducing reactive species such as H, O, and OH via plasma arc heating of injected gas(es) such as steam to enhance surface chemistry and properties of amorphous nano-sized silica particles in the form of fumed silica;
transferring the plasma arc directly to a molten silica contained in the reactor, vaporizing silica and forming SiO;
quenching the SiO, to reform SiO₂ but as amorphous nano particles; and
removing the amorphous SiO₂ nano particles in the form of fumed silica from the reactor.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is an exemplary schematic vertical cross-sectional view of a furnace for producing fumed silica, in accordance with an exemplary embodiment; and

FIG. 2 is an exemplary schematic diagram of a process for producing fumed silica, in accordance with an exemplary embodiment.

### DESCRIPTION OF VARIOUS EMBODIMENTS

The aforementioned drawbacks can be overcome by the present subject matter that uses an electric plasma arc reactor in which a plasma arc is generated at a tip of a top electrode(s) and transferred directly to a molten silica without the need for any water cooling, hence enhancing the energy efficiency of the process, eliminating the chance of water leakage, and improving the stability of the process.

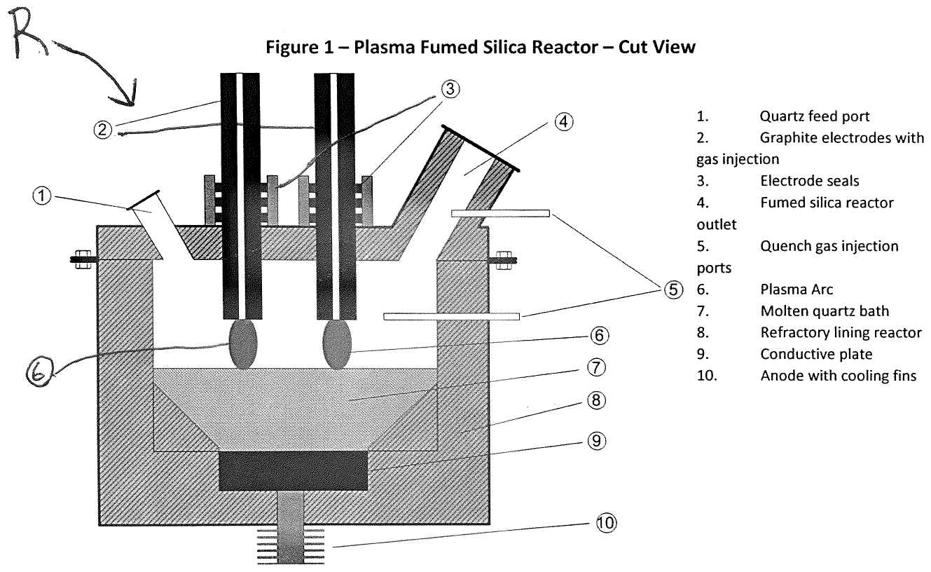

Referring to FIG. 1, there is shown a schematic representation of a plasma reactor R (plasma fumed silica reactor), wherein a stream of silica such as crushed quartz, preferably in a size range of <2 cm, is fed continuously or intermittently into the furnace through a feed port 1. The reactor R is composed of a steel shell having a refractory lining 8, designed to maintain the internal temperature of the reactor R above the melting point of the silica source, preferably of +1,700 Celsius.

The reactor R is heated using two or more electrodes 2 (graphite electrodes with gas injection), which are preferably made of graphite, for ensuring that the electrode erosion material becomes gasified and does not contaminate the fumed silica final product. The electrodes 2 are sealed by using high temperature sealant (seals) 3 for preventing excessive air infiltration in the reactor R and for allowing the process to operate under slight vacuum. Plasma arcs 6 are generated firstly between the electrodes 2 and a lower conductive plate 9 at the start of process, and create a pool of molten silica 7 (molten silica bath) which acts as a conductive medium between the plasma arcs 6 and the conductive plate 9 and it gets consumed by the plasma arcs 6 due to the vaporization process.

The electrodes 2 can be hollow cylinders, allowing for the injection of an inert plasma forming gas(es), such as argon, to attain a very high temperature plasma, and/or a reactive plasma forming gas(es) such as steam and/or a mixture of O₂ as a source of oxygen to re-oxidize the decomposition products of silica mainly SiO, and H₂ as a source of hydrogen for hydrogen bonding of the fumed silica particles. Other gases, such as ammonia, can be injected through the hollow electrode(s) 2 to lower a vaporization/decomposition temperature of the silica and/or to increase the production rate of fumed silica and/or for the same reason as that of H₂ injection.

Silica is vaporized and decomposed simultaneously at the interface of the plasma arc 6 and the molten bath of silica 7. The intense heat of the plasma arc 6 causes the silica, SiO₂, (in the form of quartz) to melt, vaporize and decompose to form SiO. The SiO is rapidly quenched using gas injection ports 5 (quench gas injections ports) using hydrogen and oxygen containing gases, such as steam or a mixture of steam and air to oxidize SiO to SiO₂ and introduce hydroxyl groups (OH—) on the surface of nano-sized amorphous silica particles. Other reagents can be introduced into the reactor R via the quench port(s) 5 to enhance the surface properties of the fumed silica, for instance to make it hydrophobic or hydrophilic. Several different quench configurations can be used, leading to different product characteristics. The SiO reacts with oxygen and reforms SiO₂ but in the form of nano-sized amorphous particles. The nano particles then aggregate to form a three-dimensional chain structure as they leave the reactor R with a gas stream through reactor outlet 4 (fumed silica reactor outlet).

The path of the electrons through the reactor R starts at the graphite electrodes 2, forms the plasma arc 6 between the electrodes 2 and the molten silica bath 7, and flows through the conductive molten silica down to the conductive plate 9, which is preferably made of Carbon-based materials such as graphite. The current then goes through a copper stem acting as anode 10 which is provided with cooling fins and which is cooled using forced air cooling. The design of the furnace also allows for the arc 6 to be ignited, or reignited if lost during operation, using the top electrodes only in an anode-cathode configuration to generate the plasma arc between the electrodes first to remelt solidified silica and then to transfer it to the molten silica by switching to the bottom anode configuration. Helium gas can be injected through the electrodes to help the arc ignition.

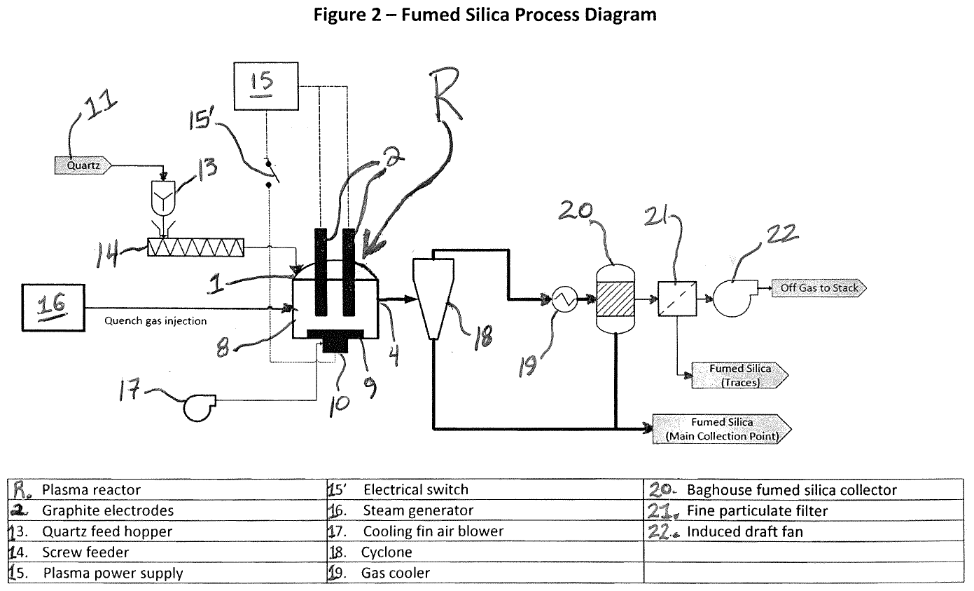

Now turning to FIG. 2, silica in the form of crushed quartz 11 is introduced into the plasma reactor R by way of an automated feeding system. Additive(s), such as metal or metal oxides that are preferably miscible in the molten silica meaning that at any operating temperature only one phase exists, one single slag phase, preferably with a vapour pressure superior to that of silica under the reactor operating conditions (such as temperature and pressure) so that the additive(s) does not co-vaporize/decomposes with silica to contaminate the fumed silica product or co-vaporize/decomposes at substantially much lower rate than that of silica, in the same form as quartz feed or in the form of powder, can be pre-mixed with quartz feed and co-fed with quartz or fed intermittently in order to enhance the electrical conductivity of molten silica and/or to improve the plasma arcing process by reducing the melting temperature of silica and providing a higher operating temperature range to minimize the chance of solidification of melt in the reactor during the operation. For instance, adding only 0.043 mol % Al₂O₃ in silica melt can reduce its melting temperature from 1723° C. to 1597° C. according to SiO₂—Al₂O₃ phase diagram [see reference 5], and yet improving its electrical conductivity by a factor of 10-20 [see reference 6].

This feeding system includes a feed hopper and mixer 13 and a screw conveyor 14. The quartz 11 is introduced intermittently or continuously into the reactor R with or without additive(s). The electrodes 2 generate a plasma arc 6 (FIG. 1) inside the reactor R using an AC/DC power supply 15, with a switch being provided at 15′. This plasma arc 6 melts and decomposes the quartz 11. A quench gas such as steam is generated at 16 (steam generator) and is injected into the reactor R. As the silica in gaseous form cools and solidifies rapidly, it forms chains of amorphous SiO₂ nano-sized particles in the form of fumed silica, which exit the reactor R in-flight with the stream of hot gas. An air blower 17 (cooling fin air blower) is used to cool down the bottom anode 10 and its electrical connection. The stream of hot gas and fumed silica particles exits the reactor R and larger size fumed silica agglomerates are collected by a cyclone 18. The stream of hot gas is cooled using an indirect gas/liquid cooler 19. A baghouse type filter 20 (baghouse fumed silica collector) is then used to separate most of the finer fumed silica particulates from the gas stream. The gas is then filtered once more with a fine particulate filter 21 to ensure that silica is not emitted into the atmosphere. An induced draft fan 22 is used to draw the gas out of the furnace and maintain the system slightly under atmospheric pressure.

The following Table summarizes the environmental benefits of the present plasma method and apparatus (reactor) for producing fumed silica versus the conventional method:

| Fumed silica (FS) | GHG Impact | Energy Consumption |
|---|---|---|
| Technology | Kg CO2 eq/kg FS | (kWh/kg SiO₂) |
| Plasma FS - Pyrogenesis | 2.5 ^{[Ref. 2]} | 12.5 ± 10% ^{[Ref. 3]} |
| Flame hydrolysis FS | 16.4 | 110 ^{[Ref. 4]} |

Therefore, the present innovative plasma arc process and apparatus for making fumed silica offers about 85% less GHG emissions and 89% less energy consumption compared to the existing industrial fumed silica making processes.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

[1] Source: PCI calculation, using data from: Brandt, B., et al., “Silicon-Chemistry Carbon Balance—An assessment of Greenhouse Gas Emissions and Reductions”, Executive Summary, Global Silicones Council et al., 2012.
[2] Assuming a Canadian average for electricity carbon intensity (0.15 t CO2 eq/MWh).
[3] Everest, D. A., Sayce, I. G. and Selton,' B., “Preparation of Ultrafine Silica powders by Evaporation Using a Thermal Plasma”, Symposium on Electrochemical Engineering, Institution of Chemical Engineers, I p.2.108-2.121 (1971).
[4] IEA PVPS Task 12, Subtask 2.0, LCA Report IEA-PVPS 12-04:2015-January 2015ISBN 978-3-906042-28-2.
[5] Strelov, K. K., Kashcheev, I. D. Phase diagram of the system Al₂O₃—SiO₂. Refractories 36, 244-246 (1995).
[6] Thibodeau, E., Jung, I H. A Structural Electrical Conductivity Model for Oxide Melts. Metallurgical and Materials Transactions B, Volume 47, Issue 1, 355-383 (2016). https://doi.org/10.1007/s11663-015-0458-z

1. A plasma arc process for producing fumed silica, including the steps of:
feeding silica, such as crushed quartz, into a plasma arc reactor;
adding additive(s) to fed silica to enhance: electrical conductivity of silica melt, and/or to lower its melting temperature, and/or to improve fumed silica production rate and/or its quality;
generating within the reactor a plasma arc at a tip of at least one top electrode;
injecting through the top electrode gasses to enhance the production of fumed silica
by reducing vaporization energy of silica,
by increasing arc power to enhance silica vaporization rate,
by introducing reactive species such as H, O, and OH via plasma arc heating of injected gas(es) such as steam to enhance surface chemistry and properties of amorphous nano-sized silica particles in the form of fumed silica;
transferring the plasma arc directly to a molten silica contained in the reactor, vaporizing silica and forming SiO;
quenching the SiO, to reform SiO₂ but as amorphous nano particles; and
removing the amorphous SiO₂ nano particles in the form of fumed silica from the reactor.

2. An apparatus for producing fumed silica, comprising a reactor adapted to generate a plasma arc, at least one top electrode extending to molten silica contained in the reactor, a conductive plate provided under the molten silica, a bottom anode, wherein a plasma arc provided at a tip of the electrode is adapted to be transferred directly to the molten silica for forming SiO, a quenching system, such as hydrogen and oxygen containing gases that are injected within the reactor, being adapted to reform SiO₂ into nano-sized amorphous particles, and an outlet for allowing fumed silica to exit the reactor.

3. The apparatus of claim 2, wherein a path of electrical current flowing through the reactor starts at the electrode, forms the plasma arc between the electrode and the molten silica, and flows through the conductive molten silica down to the conductive plate, and then through the bottom anode.

4. The apparatus of claim 2, wherein the bottom anode is provided with cooling fins, and wherein an air blower is provided for cooling the cooling fins.

5. The apparatus of claim 2, wherein the quenching system includes at least one gas injection port.

6. The apparatus of claim 2, wherein a cyclone is provided for collecting larger size fumed silica agglomerates, as a stream of hot gas and fumed silica particles exit the reactor through the outlet.

7. The apparatus of claim 1, wherein a gas/liquid cooler is provided downstream of the cyclone for cooling the stream of hot gas.

8. The apparatus of claim 7, wherein a baghouse-type filter is provided downstream of the gas/liquid cooler for separating most of the finer fumed silica particulates from the gas stream.

9. The apparatus of claim 8, wherein a fine particulate filter is provided downstream of the baghouse-type filter for further filtering the gas and removing fumed silica traces.

10. The apparatus of claim 9, wherein an induced draft fan is provided downstream of the fine particulate filter for drawing the gas out of the reactor and for providing a sub-atmospheric pressure.

11. A plasma arc process for producing fumed silica, including the steps of:
feeding silica, such as crushed quartz, into a plasma arc reactor;
generating within the reactor a plasma arc at a tip of at least one top electrode;
transferring the plasma arc directly to a molten silica contained in the reactor, vaporizing silica and forming SiO;
quenching the SiO, to reform SiO₂ but as amorphous nano particles; and
removing the amorphous SiO₂ nano particles in the form of fumed silica from the reactor.

12.-16. (canceled)
